(19) United States
(12) Patent Application Publication
(10) Pub. No.: US 2007/0079130 A1
(43) Pub. Date: Apr. 5, 2007

(54) Output copy protection

(76) Inventors: Eric Vandewater, Scottsdale, AZ (US); Peter H. Jacobs, Phoenix, AZ (US)

Correspondence Address: Michal Avniel, 668 N. 44th St., Ste. 248, Phoenix, AZ, 85008, US

(21) Appl. No.: 11/541,078

(22) Filed: Sep. 29, 2006

Related U.S. Application Data
(60) Provisional application No. 60/723,251, filed on Oct. 3, 2005.

(51) Int. Cl. H04L 9/00

(52) U.S. Cl. 713/176

(57) ABSTRACT

Output copy protection of protected digital content is provided by adding detectable digital information (watermark) to the protected digital content wherein the detectable digital information is substantially undetectable when the protected digital audio content is processed on a personal computer. Also provided is a device driver configured on a personal computer which interfaces with components on the personal computer that allows content to exit the computer wherein the device driver (i) analyzes the digital content for the presence of the added detectable digital information and (ii) allows only authorized exiting of the protected digital audio content. Output copy protection is provided to digital content that is derived from any source such as a CD, a DVD, the Internet, an MP3 file, a flashcard or a broadcast transmission.

### FIELD OF THE INVENTION

The present invention is directed to methods of preventing the transmission by a computer of unauthorized protected digital content to any destination outside the computer. In particular, the present invention provides output copy protection to protected digital content.

### BACKGROUND OF THE INVENTION

The widespread use of personal computers and Internet access has permitted extensive unauthorized digital extraction, reproduction and distribution of a significant amount of artistic content, including audio, video, software, images and text. In addition to distribution over the Internet, significant contributing factors to this unauthorized distribution include the large volume of digital content that has been made available to consumers in formats such as audio CD, CD-ROM, CD-R, DVD and DVD-R media and the ease of digital extraction and duplication of the music or other content on these physical media. Unfortunately, the standards used to produce the content for audio CDs (e.g., the IEC 60908 Redbook Standard) were not originally intended to prevent transfer of the content in digital or analog form and do not use methods to conceal the digital data on the CD for preventing unauthorized transfer.

The music and movie industries, in particular, have a strong interest in protecting its proprietary works from unauthorized copying and distribution, especially over the Internet (file sharing websites) or through other computer-based copying and distribution using music and video ripping software or other techniques. A number of attempts have been made by the music and movie industries to provide DVDs and music CDs that can be reliably played in consumer DVD players and CD players but that somehow are resistant to digital extraction by a personal computer. Although there has been some success in this area, anything less than 100 percent playability by the wide array of consumer CD players and DVD players that are already in use is extremely undesirable. When a consumer purchases a new CD or DVD he or she expects it to play in his or her equipment, and there is a great amount of anger and frustration if it does not. The record and movie industries are extremely reluctant to take the risk of this happening to its end consumers who appropriately purchase its music and movie offerings. Many consumers who purchase music on compact discs expect to be able to play them on their computers, or at least to extract the music to their hard drives using software that contains a digital rights management protocol, such as Windows Media Player®. Consumers also expect to be able to play DVDs on their computers.

Because the Internet provides almost instantaneous distribution of digital content around the globe once unprotected digital content is released to the public, it is highly desirable to devise a method of protecting proprietary works from indiscriminate copying and distribution while at the same time allowing the proprietor to maintain control over his/her protected works. Additional copy protection systems for audio CDs and DVDs are always desirable as long as the additional systems do not adversely affect playability, on standard CD and DVD players and their personal computers (PC).

The present invention provides copy protection to not only protected works distributed over the Internet but also to music CDs, DVDs and any protected digital content from any digital source being input into a personal computer. The present invention prevents output of unauthorized digital content from the computer. In the case of CDs and DVDs this additional copy protection is above and beyond any other active or passive copy protection that may be present on the CD or DVD and does not adversely effect playability.

### BRIEF SUMMARY OF THE INVENTION

Briefly, in accordance with the present invention, the transmission of an unauthorized protected digital content from a digital source by a personal computer to a destination outside said computer is prevented or stopped by (i) adding detectable digital information to the protected digital content wherein the detectable digital information is substantially undetectable when the protected digital content is processed on the personal computer and (ii) providing a device driver configured on the personal computer which interfaces with components on the personal computer that allow content to exit the computer wherein the device driver (i) analyzes the digital content for the presence of the added detectable digital information and (ii) allows only authorized exiting of the protected digital content from the computer. The detectable digital information is preferably a watermark. The source of digital content can be any source such as, for example a CD, a DVD, the Internet, an MP3 file, a flashcard or a broadcast transmission. The components on the personal computer that allow content to exit the computer are any components that deliver analog or digital information to a remote destination, such as, for example, a speaker, a CD drive, a DVD drive, a floppy disc drive, a flashcard, the Internet, a network or any device configured to the computer.

Of particular interest in practicing the invention the copying and playing of an unauthorized protected digital audio content from a digital source by a personal computer is prevented by (a) adding detectable digital information (watermark) to the protected digital audio content wherein the detectable digital information is substantially inaudible when the protected digital audio content is played, and (b) providing an audio device driver configured on the personal computer which interfaces with the sound card on the personal computer wherein the audio device driver (i) analyzes the audio digital content for the presence of the added detectable digital information and (ii) allows only authorized copying and/or playing of the protected digital audio content. Once again the source of the digital content can be any digital source but is preferably an audio CD or an enhanced CD where all of the audio tracks have a watermark that is detectable by the audio device driver. As the sound card processes the digital information the audio device driver analyzes the digital information for the presence of a watermark. If a watermark is present the audio device driver further analyzes the watermark to determine of the digital information is authorized or unauthorized. If authorized the digital information is allowed to exit the sound card. If unauthorized the digital information is not allowed to exit the sound card and the processing step in the sound card is terminated.

Additionally, the present invention relates to an audio device driver for use as a component in a personal computer that contains an audio sound card. The audio device driver contains a software program that interfaces with the sound card wherein the software program (i) analyzes audio digital content received by the sound card for the presence of identifying detectable digital information and (ii) allows only authorized copying of the protected digital audio content

### BRIEF DESCRIPTION OF THE DRAWINGS

FIG. 1 shows a flow diagram showing aspects of the present invention.

FIG. 2 is a diagram showing protected content being transmitted from a computer via device drivers.

### DETAILED DESCRIPTION OF THE INVENTION

The following definitions apply when used herein:

A “personal computer” means any computer regardless of manufacturer or operating system and includes an Apple computer.

The term “exit gate” means any means or computer component that allows data to exit the computer. Exit gates include but are not limited to a soundcard, a CD drive, a DVD drive, a floppy disc drive, a flashcard, the Internet, a network or any device in communication with the computer.

The term “device driver” means a software program installed on a personal computer to perform one or more functions.

In practicing the present invention data in a computer is analyzed before exiting the computer to determine if the data has protected digital content. If protected digital data is detected then authorized data is allowed to exit the computer and unauthorized data is prohibited from exiting the computer.

The transmission of an unauthorized protected digital content from a digital source by a personal computer to a destination outside said computer is prevented or stopped by first adding detectable digital information to the protected digital content before the protected digital data downloaded into the computer. The detectable digital information is a watermark and is substantially undetectable when the protected digital content is processed on the personal computer. In the case of an audio file the watermark is substantially inaudible to the normal hearing of people. In the case of a video file the watermark is substantially invisible to normal human sight. The watermark identifies the digital work as being copy protected. The watermark also can dictate the terms of any further use of the protected digital content such as for example, the number of copies of the protected digital content that may be made if any, the number of times the digital content may be used, the length of time that the digital content may be used, whether or not the digital content may be transmitted over the Internet and the like.

In addition to embedding a watermark in the protected digital content, one or more device drivers are installed and configured on the personal computer which interface with exit gate components on the personal computer that allow content to exit the computer. The device driver (i) analyzes the digital content for the presence of the added detectable digital information or watermark and (ii) allows only authorized exiting of the protected digital content from the computer.

The device drivers are computer programs that are able to detect the presence of a watermark in the digital content. Once a watermark is detected the device driver will determine if the digital content is authorized and if it is the device driver will allow the transmission of the protected digital content from the computer to its intended destination. If the digital content is not authorized then the device driver will abort the transmission of the protected digital content to a remote site outside the personal computer.

The source of digital content before it is downloaded onto the computer is not critical to the practice of the present invention and can be any source such as, for example a CD, a DVD, the Internet, an MP3 file, a flashcard or a broadcast transmission. The digital content, of course, must have a watermark embedded within it in order to be protected from unauthorized uses according to the present invention. In a preferred embodiment the source of the digital content is an audio CD or an enhanced CD that has been downloaded onto the personal computer wherein each audio track contains a watermark.

The exit gates are any components on the computer that deliver analog or digital information to a remote destination, such as, for example, a speaker, a soundcard, a CD drive, a DVD drive, a floppy disc drive, a flashcard, the Internet, a network or any device in communication with the computer. As described above, the device drivers interface with the exit gates to monitor outgoing digital content for the presence of detectable digital information (watermark) so that unauthorized transmissions of the protected digital content can be prohibited.

In a preferred embodiment of the present invention, the unauthorized copying or playing of an unauthorized protected digital audio content from a digital source by a personal computer is achieved adding detectable digital information (watermark) to the protected digital audio content wherein the detectable digital information is substantially inaudible when the protected digital audio content is played. A preferred digital source is an audio CD or an enhanced CD. Additionally, an audio device driver is installed and configured on the personal computer to interface with the sound card on the personal computer. The audio device driver (i) analyzes the audio digital content for the presence of the added detectable digital information and (ii) allows only authorized copying and/or playing of the protected digital audio content by the soundcard. In similar embodiments a specific device driver is installed for any desirable exit gate. As can be appreciated the present invention provides additional copy protection to protected digital content over and above any other passive or active copy protection technology present on an audio or enhanced CD.

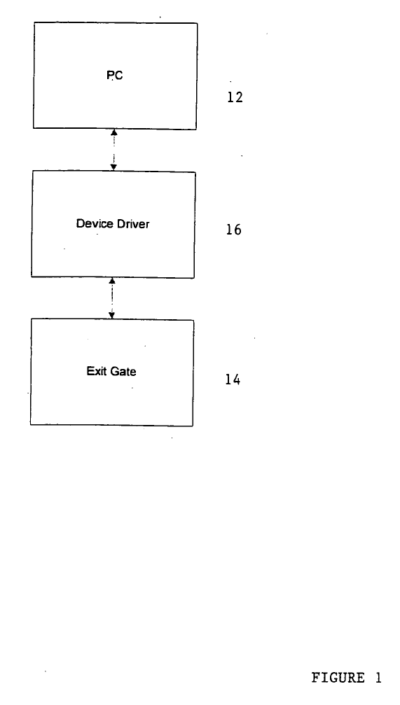

Referring to FIG. 1, a PC 12 contains protected digital content from any source. When the computer user attempts to perform an operation on the computer that delivers any digital content to an exit gate 14 that interfaces with a device driver 16 that digital content will be analyzed for the presence of a watermark. If the device driver 16 detects the watermark then it will determine if the digital content is authorized or not. If it is authorized then operation on the computer will be allowed to proceed. If it is unauthorized then the operation will be aborted.

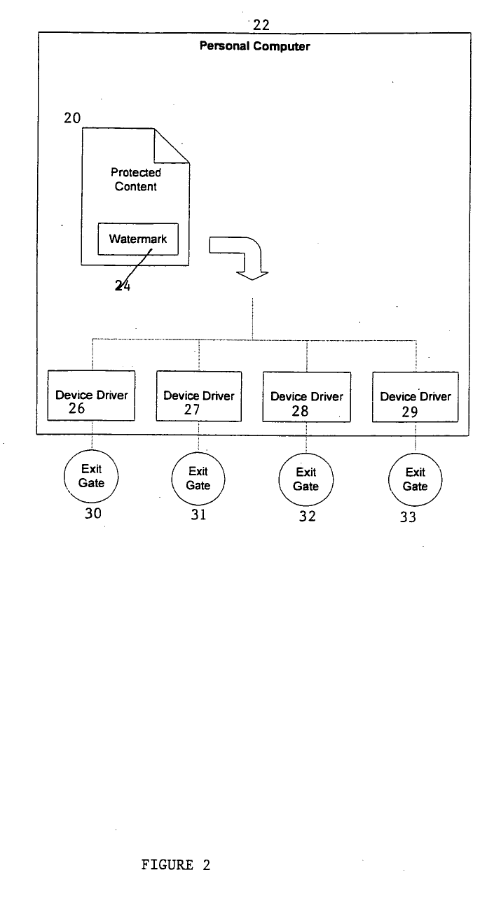

Referring now to FIG. 2, prior to the protected content 20 being downloaded onto the computer 22 a watermark 24 is embedded within the protected content 20. The watermark 24 will identify if the protected digital content 20 is authorized or unauthorized. Any one or more device drivers 26, 27, 28, 29 are installed onto the computer to interface with an exit gates 30, 31, 32, 33 respectively. The device drivers 26, 27, 28, 29 are programmed to detect the watermarks 24 that have been embedded within the digital content. If a computer operation is initiated that sends digital information through an exit gate 30, 31, 32, 33, that interfaces with a device driver 26, 27, 28, 29 it will analyze the protected digital content 20 to determine if a watermark 24 is present. If a watermark 24 is detected then the device driver 26, 27, 28, 29 will determine if the protected digital content 20 is authorized. If it is authorized then operation on the computer will be allowed to proceed. If it is unauthorized then the operation will be aborted.

In operation, a computer user installs a device driver onto a personal computer wherein the device driver is programmed to detect particular watermarks and whether or not the specific watermarks indicate if a protected digital content is authorized or not. As the computer user initiates operations that direct digital information to an exit gate that interfaces with the device driver the device driver will analyze the digital content for the presence of a watermark. If no watermark is detected then the computer operation is allowed to proceed utilizing the particular exit gate. If a watermark is detected and the protected digital content is authorized then the computer operation is also allowed to proceed utilizing the particular exit gate. If a watermark is detected and the protected digital content is unauthorized then the device driver will abort the computer operation attempting to utilize the particular exit gate.

The above description describes several embodiment of the present invention and should not be construed to limit the scope of the inventions described in the following claims.

We claim:

1. A method of preventing the transmission of an unauthorized protected digital content from a digital source by a personal computer to a destination outside said computer which comprises:
a. adding detectable digital information to the protected digital content wherein the detectable digital information is substantially undetectable when the protected digital content is processed on the personal computer, and
b. providing a device driver configured on the personal computer which interfaces with components on the personal computer that allow content to exit the computer wherein the device driver (i) analyzes the digital content for the presence of the added detectable digital information and (ii) allows only authorized exiting of the protected digital content from the computer.

2. The method of claim 1 wherein the digital source is an audio or a video digital source and the detectable digital information is a watermark.

3. The method of claim 2 wherein the components on the personal computer that allow content to exit the computer are any components that deliver analog or digital information to a speaker, a CD drive, a DVD drive, a floppy disc drive, a flashcard, the Internet, a network or any device configured to the computer.

4. The method of claim 2 wherein the protected digital content is (a) audio content and the device driver is an audio device driver that interfaces with a sound card on the personal computer or (b) video content and the device driver is a video device driver that interfaces with a video card on the personal computer.

5. A method of preventing the copying by a personal computer of an unauthorized protected digital audio content from a digital source which comprises:
a. adding detectable digital information to the protected digital audio content wherein the detectable digital information is substantially inaudible when the protected digital audio content is played, and
b. providing an audio device driver configured on the personal computer which interfaces with the sound card on the personal computer wherein the audio device driver (i) analyzes the audio digital content for the presence of the added detectable digital information and (ii) allows only authorized copying and/or playing of the protected digital audio content.

6. The method of claim 5 wherein the detectable digital information is a watermark.

7. The method of claim 6 wherein the digital source is derived from a CD, a DVD, the Internet, an MP3 file, a flashcard or a broadcast transmission.

8. The method of claim 7 wherein the digital source is derived from an audio CD or an enhanced CD.

9. The method of claim 8 wherein the CD or enhanced CD has a watermark in every audio track.

10. A method of preventing the playing by a personal computer of an unauthorized protected digital audio content from a digital source which comprises:
a. adding detectable digital information to the protected digital audio content wherein the detectable digital information is substantially inaudible when the protected digital audio content is played, and
b. providing an audio device driver configured on the personal computer which interfaces with the sound card on the personal computer wherein the audio device driver (i) analyzes the audio digital content for the presence of the added detectable digital information and (ii) allows only authorized copying of the protected digital audio content.

11. The method of claim 10 wherein the detectable digital information is a watermark.

12. The method of claim 11 wherein the digital source is derived from a CD, a DVD, the Internet, an MP3 file, a flashcard or a broadcast transmission.

13. The method of claim 12 wherein the digital source is derived from an audio CD or an enhanced CD.

14. The method of claim 13 wherein the CD or enhanced CD has a watermark in every audio track.

15. An device driver for use as a component in a personal computer that contains one or more exit gates, said device driver comprising a software program that interfaces with the exit gate wherein the software program (i) analyzes digital content received by the exit gate for the presence of identifying detectable digital information and (ii) allows only authorized transmission of the protected digital content from the exit gate.

16. The device driver of claim 15 wherein the exit gate is a sound card, a CD drive, a DVD drive, a floppy disc drive, a flashcard, an internet Internet cable, or a network cable.

17. The device driver of claim 15 wherein the detectable digital information is a watermark.

18. The device driver of claim 15 wherein the digital content received by the exit gate is audio content or video content.

19. An audio device driver for use as a component in a personal computer that contains an audio sound card which comprises a software program that interfaces with the sound card wherein the software program (i) analyzes audio digital content received by the sound card for the presence of identifying detectable digital information, (ii) determines whether or not the audio digital content is authorized or unauthorized and (iii) prohibits the playing of unauthorized protected digital audio content.

20. The audio device driver of claim 19 wherein the detectable digital information is a watermark.

21. An video device driver for use as a component in a personal computer that contains a video card which comprises a software program that interfaces with the video card wherein the software program (i) analyzes digital content received by the video card for the presence of identifying detectable digital information, (ii) determines whether or not the digital content is authorized or unauthorized and (iii) prohibits the playing of unauthorized protected digital audio content.

22. The video device driver of claim 21 wherein the detectable digital information is a watermark.

23. A method of preventing the copying by a personal computer of an unauthorized protected digital video content from a digital source which comprises:
a. adding detectable digital information to the protected digital video content wherein the detectable digital information is substantially invisible when the protected digital video content is played, and
b. providing a video device driver configured on the personal computer which interfaces with the video card on the personal computer wherein the video device driver (i) analyzes the video digital content for the presence of the added detectable digital information and (ii) allows only authorized copying and/or playing of the protected digital video content.

24. The method of claim 23 wherein the detectable digital information is a watermark.

25. The method of claim 23 wherein the digital source is derived from a CD, a DVD, the Internet, a flashcard or a broadcast transmission.
